(19) United States
(12) Patent Application Publication
(10) Pub. No.: US 2023/0330880 A1
(43) Pub. Date: Oct. 19, 2023

(54) METHOD AND SYSTEM FOR AUTOMATIC CUTTING OF PIECES IN A FLEXIBLE MATERIAL PACKAGED IN ROLL FORM

(71) Applicant: LECTRA, Paris (FR)

(72) Inventors: Stéphane BODIVIT, Cestas (FR); Loic JÉZÉQUEL, Gradignan (FR); Christelle GUERRERO, Cestas (FR)

(21) Appl. No.: 18/011,763

(22) PCT Filed: Jun. 24, 2021
(86) PCT No.: PCT/FR2021/051159

§ 371 Date: Dec. 20, 2022

(30) Foreign Application Priority Data
Jun. 29, 2020 (FR) 2006825

(51) Int. Cl. B26D 5/00; B26F 1/38

(52) U.S. Cl. CPC B26D 5/00; B26F 1/3806; B26F 2210/12

(57) ABSTRACT

A method and a system are provided for automatically cutting parts in a flexible material packaged in a roll. The method and system include the successive steps of preparing an initial placement, spreading a layer of flexible material on a cutting table, starting the automatic cutting of the parts in the material spread according to the initial placement, during the cutting, upon receipt of a triggering event for which the placement of at least one of the parts is no longer adapted to the cutting environment or for which the list of the parts of the initial placement needs to be modified, preparing a list of parts to be maintained, and automatically preparing a new placement taking into account the position of the parts to be maintained and calculating new positions for at least some of the other parts without taking into account their positions in the initial placement.

### TECHNICAL FIELD

The invention relates to the general field of the automatic cutting of parts in a flexible material packaged in the form of a roll. It more particularly concerns the management of triggering events occurring during the cutting on the parts and likely to affect the quality and efficiency of the cutting.

Fields of application of the invention are in particular the clothing and furniture industries.

### PRIOR ART

The automatic cutting of parts in a flexible material is typically performed on a conveyor cutting machine piloted from a control station.

The cutting process takes place as follows. The operator receives on the control station a list of cutting works to be carried out which has been prepared in advance. Each of these works contains all the information necessary to make a cutting, namely: a placement of the parts to be cut out and a material on which the cutting will be made.

The used materials (flexible material) are generally packaged in the form of rolls which are loaded on the supply module of the cutting machine. The material is then progressively transported via the conveyor on the different modules of the cutting machine, namely: a cutting module at which the cutting of the parts takes place, and an unloading module where the operator collects the cut-out parts. In the case of a cutting machine processing patterned fabrics, a module for acquiring the material is also provided to scan the latter upstream of the cutout module.

Once the material has been transported to the cutting module, the system knows the relative position of the parts relative to each other thanks to a placement previously prepared and stored at the level of the cutting work. In order to correctly cut these parts on the material, the operator must also proceed to the positioning of this placement on the material.

The preparation of the placement of the parts is carried out in such a way as to fully optimize the consumption of the material but also to obtain a high-quality cutting result. For that, constraints can be imposed by the cutting support. For example, the usable strip width can impose a limitation on the area of placement of the parts. Similarly, the type of material used can impose a minimum proximity distance between some parts.

In addition to these constraints imposed by the cutting support, additional constraints can be imposed by designers and modelers during the creation phase. This may be, for example, meeting the straight grain of the fabric which imposes defined rotation values or, in the case of patterned fabrics, connection constraints which impose a position dependence between the parts.

Once the operator launches the production on the piloting station of the cutting machine, the system will activate the supply module automatically from the material data contained in the first cutting work of the list. On the supply module, the operator will be able to load the roll corresponding to the material given to him. Depending on the machine options, the operator can specify the direction and the visible face of the material. This action will be done either on the piloting station or on the supply module.

Once this step has been validated, the material is transported to the cutting module while passing through the possible acquisition module. The latter allows digitizing the material spread on the cutting table and giving the actual characteristics of the material to the operator.

Once the material has been transported to the cutting module, the operator positions the placement in the right place on it using the image provided by the acquisition module or with a pointing tool embedded on the cutting head and the cutting can start.

During the production, several differences between the theoretical information (given beforehand in the cutting work) and the actual information (noted by the operator or specific to the roll in the process of cutting) may appear and make the preparation of the placement obsolete. These differences, if they are not taken into account, can have an impact on the quality of the result of the cutting or on the efficiency obtained. To do so, several adaptations of the placement in production can be made.

Furthermore, during the cutout of a placement, it is possible that the roll of material ends and that the material available is no longer sufficient to finish the cutout of the placement that has been started.

To overcome this problem, one of the known solutions consists in asking the operator to show the end of the current roll in order to split the placement into two portions so as to avoid the “change” area between the rolls.

This solution of the prior art is illustrated by FIGS. 1A to 1C. FIG. 1A represents a plurality of parts P1 to P10 of a placement in the process of cutting. The parts P1 to P3 have already been cut out in the current roll Rc (and have reached the unloading module), the part P4 is in the process of being cut, while the parts P5 to P10 are not yet cut out (or partially cut, or even completely cut). Furthermore, it is noted in this FIG. 1A that the parts P5 and P6 are positioned astride the end of the current roll Rc (on which the parts P1 to P4 are cut out) and the parts P7 to P10 are positioned beyond the end of the current roll.

From this information, the operator delimits a roll change area Z represented in FIG. 1B. As illustrated in FIG. 1C, the parts P5 to P7 which are located in this area Z will not be cut out on the current roll Rc and will be placed on the following roll Rs to be cut out there. More specifically, the placement of the parts P1 to P10 is split into two with the parts P5 to P10 which will be shifted in the placement to be cut out in the next roll Rs.

This solution of the prior art allows limiting the number of parts on the roll change and which should be rejected. However, as perfectly illustrated by FIG. 1C, having to split the existing placement into two portions can result in a significant loss of material.

Such a solution is also used to avoid defect areas in the material: the beginning of the defect area is assimilated to the end of the current roll, and the end of the defect area is assimilated to the beginning of the next roll, the space between the two rolls thus being considered as a defect area.

In practice, if a defect is detected before the cutout of the parts on this defect area, the operator may want to avoid cutting out parts that will not be usable later. The known solution he has consists in splitting the placement into two portions as described above for the roll end problem in order to avoid the defect area. This solution therefore has the same drawbacks as stated above, namely a significant loss of material.

Furthermore, during the unloading of the parts, the operator may notice a defect on a part making it unusable. In this case, he has the possibility of “rejecting” it. Once the placement has been completely cut and unloaded, all of the rejected parts are then recut by assigning them to a new placement.

This solution allows recutting the parts having a quality problem and therefore producing all the desired parts in a usable way. But the lower the number of rejected parts, the greater the risk of loss of material. In addition, having to wait for the new placement to recut these rejected parts can lead to a loss of production time.

More generally, the placement prepared in advance of the production and given in the cutting work is most often sufficient in the cutting process. However, it often happens that this placement must be modified to take into account the problems mentioned above. Today, the solutions proposed to overcome these problems consist of adaptations of the existing initial placement: the position of the parts is slightly shifted, or the part is rejected in order to be recut out in a new additional placement.

These adaptations have the advantage of avoiding quality problems. On the other hand, the modified placement generates a significant loss of material and an additional duration of production.

### DISCLOSURE OF THE INVENTION

The aim of the present invention is therefore to propose a cutting process that does not have the aforementioned drawbacks when a triggering event occurs during the cutting of the placement.

In accordance with the invention, this aim is achieved thanks to a method for automatically cutting parts in a flexible material packaged in the form of a roll, comprising the successive steps of:
a) preparing an initial placement for a list of parts to be cut out in the flexible material;
b) spreading at least one layer of flexible material on a cutting table;
c) starting the automatic cutting of the parts in the material spread on the cutting table according to the initial placement;
d) during the cutting of the initial placement, upon receipt of a triggering event for which the placement of at least one of the parts is no longer adapted to the cutting environment or for which the list of the parts of the initial placement needs to be modified, preparing a list of parts to be maintained; and
e) automatically preparing a new placement taking into account the position of the parts to be maintained and calculating new positions for all or part of the other parts—called parts to be repositioned—without taking into account their positions in the initial placement.

The method according to the invention is remarkable in that it provides, in case of receipt of a triggering event during the cutting of the placement, automatically preparing a list of parts to be maintained, then preparing a new placement different from the initial placement, this new placement taking into account the position of the parts to be maintained and calculating new positions for all or part of the other parts to be repositioned.

Thus, in case of detection of a roll end or of a cutting defect for example, the method according to the invention proposes to perform a re-calculation of the placement of all or part of the other parts to be repositioned in order to generate a new optimized placement allowing significant material gains. By “new placement”, it is meant here a placement of the parts to be repositioned in their entirety which is prepared without taking into account the position of the parts as defined in the initial placement. Particularly, this new placement is not just a simple optimization of the initial placement.

In addition, the method according to the invention allows obtaining significant productivity gains insofar as it is possible to maintain a minimum cutting time during which the new placement is generated, which avoids any production stop.

Preferably, step e) is followed by a step f) of automatically cutting the parts in the material spread on the cutting table according to the new placement.

The new placement prepared in step e) can comprise all or part of the parts of the initial placement that are still to be cut out. In this case, the new placement prepared in step e) can further comprise one or several parts for which the placement is no longer adapted to the cutting environment.

Also preferably, step d) comprises the determination of the number of the parts to be maintained that are still to be cut out according to an evaluation of their cutting time and to the time allocated to the calculation of the new placement. In this case, the time allocated to the calculation of the new placement is advantageously less than the evaluation of the cutting time of the parts to be maintained that are still to be cut out.

Preferably again, the selection of the parts of the new placement among all the parts of the initial placement that are still to be cut out is made by meeting any constraints of placement of said parts.

The triggering event can be chosen among a detection of the end of the roll on which the material spread on the cutting table is packaged, a detection of a defect on the material spread on the cutting table, and a detection of a defect on a cut out part that needs to be recut.

When the triggering event consists of the detection of the end of the roll on which the material spread on the cutting table is packaged, step e) can comprise the establishment of a first placement of parts on the end of the roll, and a second placement of the remaining parts on another roll of material.

When the triggering event consists of the detection of a defect on the material spread on the cutting table, step e) can comprise the exclusion of the area of the spread material on which the defect is present in order to establish the new placement.

When the triggering event consists of the detection of a defect on a cut out part that needs to be recut, step e) can comprise the addition of the defect part to the new placement.

Advantageously, the new placement of step e) is prepared so as to minimize any loss of productivity. To this end, step e) can be carried out without interrupting the cutting of the parts to be maintained that are still to be cut out according to the initial placement.

Also advantageously, step e) of preparing the new placement is carried out iteratively in order to obtain the highest possible efficiency rate.

Step c) can comprise a prior step of modifying the initial placement to generate an actual placement of the parts on the spread material which takes into account the actual characteristics of the material.

The invention also relates to a system for automatically cutting parts in a flexible material packaged in the form of a roll, comprising:
means for preparing an initial placement of a list of parts to be cut out in the flexible material;
a cutting table on which at least one layer of flexible material can be spread;
means for automatically cutting the parts in the material spread on the cutting table according to the initial placement;
means for receiving, during the cutting of the initial placement, a triggering event for which the placement of at least one of the parts is no longer adapted to the cutting environment or for which the list of the parts of the initial placement needs to be modified; and means for automatically preparing a list of parts to be maintained and a new placement taking into account the position of the parts to be maintained and calculating new positions for all or part of the other parts—called parts to be repositioned—without taking into account their positions in the initial placement.

### BRIEF DESCRIPTION OF THE DRAWINGS

FIGS. 1A to 1C already described illustrate one example of management of a roll end according to the prior art.

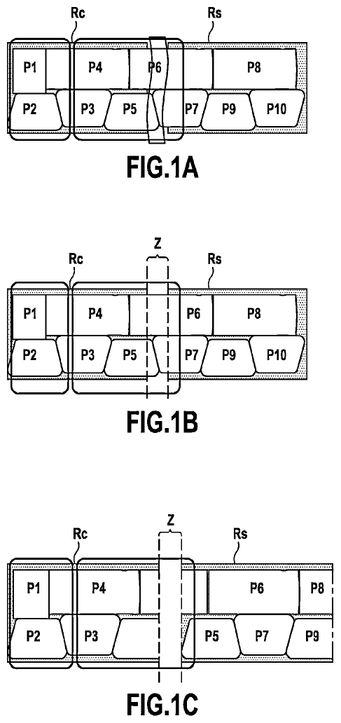

FIG. 2 is a schematic view of the different modules of a cutting system for the implementation of the method according to the invention.

FIG. 3 is a flowchart representing different steps of the method according to the invention.

FIGS. 4A and 4B illustrate one example of implementation of the method according to the invention upon detection of the roll end.

FIGS. 5A and 5B illustrate one exemplary implementation of the method according to the invention upon detection of a defect on the material.

FIGS. 6A and 6B illustrate one exemplary implementation of the method according to the invention upon detection of a defect on a cut out part that needs to be recut.

FIGS. 7A and 7B illustrate another exemplary implementation of the method according to the invention upon detection of a defect on a cut out part that needs to be recut.

FIGS. 8A to 8C illustrate one exemplary implementation of step d) of the method according to the invention consisting in preparing a list of parts to be maintained.

FIGS. 9A to 9C represent different steps of one exemplary implementation of step e) of the method according to the invention consisting in preparing a new placement.

### DESCRIPTION OF THE EMBODIMENTS

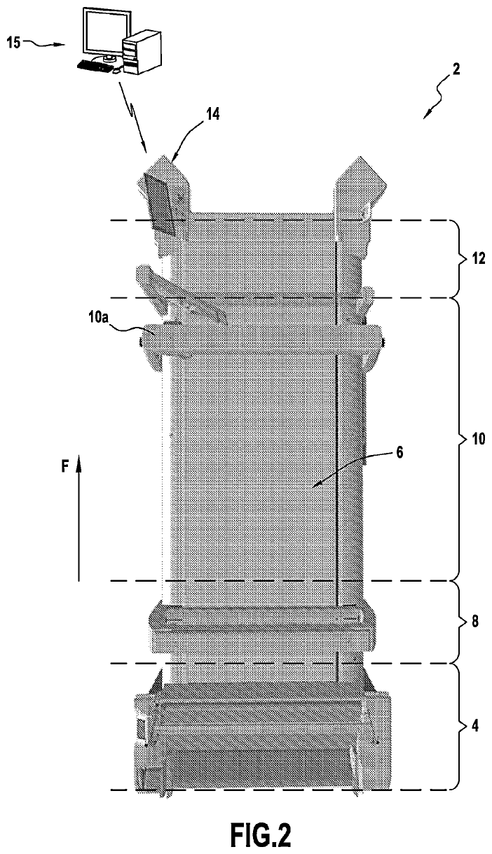

The invention relates to the automatic cutting of a plurality of parts in a flexible material packaged in the form of a roll by means of a cutting system such as the one represented in FIG. 2.

In a known manner, such a cutting system 2 can be made up of four modules through which the material passes, namely (from upstream to downstream in the advancing direction F of the material): a supply module 4 positioned at one end of the cutting table 6, an acquisition module 8 (optional), a cutting module 10 and an unloading module 12 positioned at another end of the cutting table.

The supply module 4 is intended to receive the material to be cut packaged in the form of a roll. The acquisition module 8 is an optional module which is intended to scan the material spread on the cutting table. The cutting module 10 comprises a movable gantry 10a on which a cutting tool is mounted to carry out the cutting of the parts. As for the unloading module 12, it is used by the operator to unload the cut-out parts outside the table.

The flexible material to be cut out is driven onto the cutting table 2 by a conveyor from the supply module 4 to the unloading module 12. The cutting system 2 also comprises a control station 14 allowing the operator to program a piloting of the different modules according to the material to be cut out and to the cutting works to be carried out.

In practice, the operator receives on the control station 14 from a computer workstation 15 the information needed to perform a cutting, namely (for each of the cutting works): an initial placement of a list of parts to be cut out, and a material on which the cutting is to be made.

The flexible material of a cutting work represents the fabric from which the parts must be cut. Each material is associated with a set of previously recorded technical characteristics (in particular the color, the description of any pattern, the strip width, etc.).

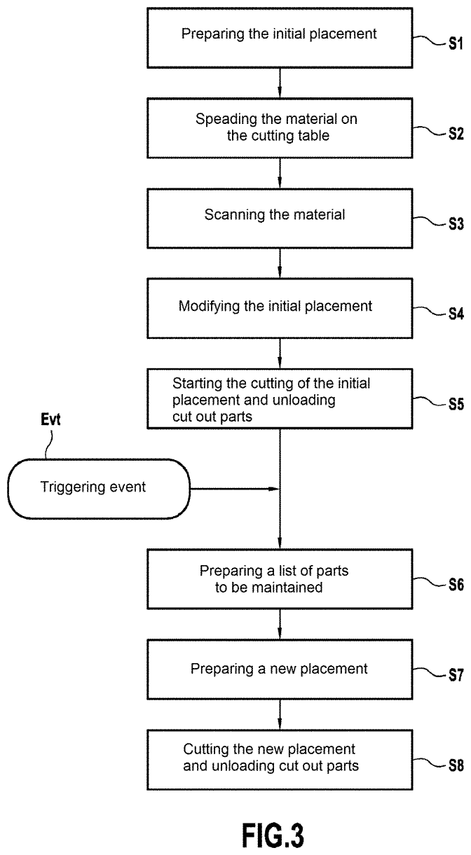

FIG. 3 is a flowchart of the different steps of the method according to the invention for the automatic cutting of parts in a flexible material packaged in the form of a roll, these different steps being in particular implemented using a cutting system such as the one described in relation to FIG. 2.

The first step S1 of the method consists in preparing an initial placement for a list of parts to be cut out in the flexible material.

The placement is manually or automatically prepared, most often by a dedicated operator (different from the one handling the cutting system), in order to fully optimize the consumption of the material but also to obtain a high-quality cutting result.

In a known manner, the placement takes into account the constraints imposed by the cutting support, such as for example the strip width (which imposes a limitation of the placement area) and the type of material used (which imposes a minimum proximity distance between the parts), but also the constraints imposed by the designer and/or modeler, such as for example meeting the straight grain of the fabric and, in the case of a patterned fabric, the constraints of connection between the parts and of pattern point.

Particularly, in the case of a material consisting of a patterned fabric, the initial placement is prepared by taking into account the constraints of connections between the parts. For example, reference can be made to the patent application FR 20 02947 filed on Mar. 26, 2020, by the Applicant, which describes a method for preparing a placement of parts with constraints of placement of parts in a patterned fabric.

The next step S2 of the method according to the invention consists in spreading a layer of material to be cut out on the cutting table.

Typically, once the operator has launched the production on the control station, the cutting system will activate the supply module automatically from the material data contained in the first cutting work of the list. On the supply module, the operator will be able to load the roll corresponding to the material provided to him.

This supply module is generally equipped with sensors and actuators for ensuring the unwinding of the roll and a laying of the fabric without tension, without folds and well aligned. This module is generally equipped with a fabric presence detector. This detector can identify the end of a roll. The measurement of the tension of the fabric also allows detecting the end of the roll in the case where the end of the fabric is bonded on the central mandrel of the roll.

The material is then transported on the cutting table to the cutting module. Depending on the configuration of the system, the fabric may pass through an acquisition module where new information on the material is recorded. This acquisition module can be a scanner recording and analyzing an image of the material, a simple detector placed above the selvage of the fabric and detecting a mark indicating the presence of a defect on the fabric or any other device providing information on the material before the cutting (step S3).

This step S3 allows taking into account any differences that may exist between the theoretical information of the material (given beforehand in the cutting work) and the actual information observed by the operator or specific to the roll in the process of cutting. These differences are due to print defects, defects of laying a fabric on the cutting table, variations in the density of the yarns of the loom and/or deformations of the fabric which may result in irregularities in the pattern repetition pitch.

If they are not taken into account, these differences can have a consequence on the quality of the result of the cutting. Also, it is planned to automatically modify or adjust the initial placement (step S4) so that it can correspond to the reality of the fabric spread on the cutting table. One example of modification of the initial placement is described in the publication EP 0,759,708.

The next step S5 of the method according to the invention then consists in starting the cutting of the initial placement (possibly modified during step S4). This operation is carried out at the level of the cutting module of the cutting system.

During this step, the material moves on the cutting table and the different parts are cut out according to the possibly modified initial placement.

When the cut-out parts arrive at the level of the unloading module of the cutting system, they are collected by the operator.

During or at the end of this step S5, it is possible for a triggering event Evt to occur. Different types of triggering events are concerned here: a detection of the end of the roll on which the material spread on the cutting table is packaged, a detection of a defect on the material spread on the cutting table, and a detection of a defect on an already cut out part that needs to be recut.

This triggering event can occur automatically (for example in the case of a defect on the material spread on the cutting table which can be detected by the acquisition module of the cutting system) or manually by the operator.

In both cases, as soon as such a triggering event occurs, it is signaled to the operator and the information is sent to the control station to be processed.

Upon receipt of this information, a list of parts to be maintained is automatically prepared (step S6 of the method). The parts in this list are the parts for which the new placement prepared in the next step S7 will not modify the position. For example, the parts that have already been cut out and that do not need to be recut form part of this list of parts to be maintained.

During the next step S7, the automatic placement module automatically prepares a new placement.

This new placement is prepared independently of the initial placement prepared in step S1. The new placement nevertheless takes into account the position of the parts to be maintained (resulting from step S6) and calculates new positions for all or part of the other parts (called parts to be repositioned), these new positions not taking into account the positions of the parts to be repositioned in the initial placement. Moreover, this new placement meets the constraints imposed on the initial placement.

The new placement is prepared so as to minimize any loss of productivity. Particularly, it is advantageously prepared without interrupting the cutting of the parts to be maintained that are still to be cut according to the initial placement.

Different examples of preparation of the new placement based on the different possible triggering events will be described later.

Finally, the last step S8 of the method consists in continuing the cutting according to the new placement (at the level of the cutting module of the cutting system). When the cut-out parts arrive at the level of the unloading module of the cutting system, they are then collected by the operator.

It should be noted that a triggering event may occur during the cutting step S8 according to the new placement, in which case the steps S6 to S8 are repeated.

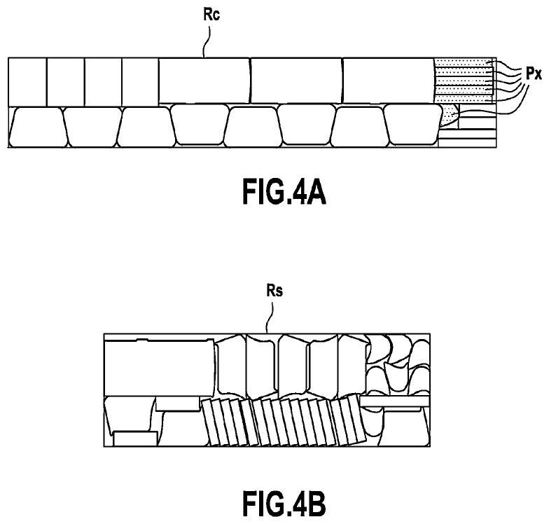

In relation to FIGS. 4A and 4B, one exemplary implementation of the preparation of a new placement in the case of a triggering event consisting of the detection of the end of the roll on which the material spread on the cutting table is packaged will now be described.

In this example, the length of the current roll Rc on which the material spread on the cutting table is packaged is not sufficient to cut out all the parts of the initial placement (FIG. 4A). The remaining parts must therefore be produced on the next roll Rs.

In order to produce the parts of the next roll Rs (FIG. 4B), all the steps prior to the cutout will have to be carried out (in particular loading of the material, identification of the placement on the cutting area, etc.). To carry out these steps normally and independently of the completion of the end of the current roll Rc, a second cutting work will be created. The latter will have its own placement (containing all the parts that must be cut on the next roll).

In the case of the processing of the end of the rolls, two new placements will therefore be necessary:

a first new placement to optimize the efficiency of the parts Px at the end of the current roll Rc a second new placement to optimize the efficiency of the parts Py associated with the next roll

Rs

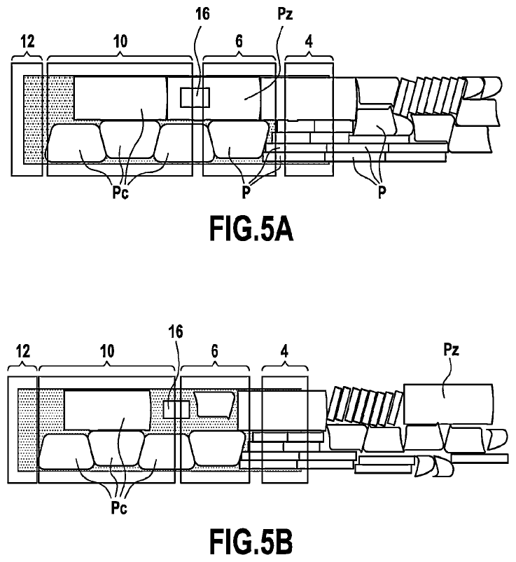

In relation to FIGS. 5A and 5B, one exemplary implementation of the preparation of a new placement in the case of a triggering event consisting of the detection during the cutting of a defect on the material spread on the cutting table will now be described.

FIG. 5A represents a placement of parts P in the process of cutting by a cutting system such as the one described in relation to FIG. 2.

During the cutting, the acquisition module 6 (or the operator) detects a defect on the material spread on the cutting table at the level of a defect area 16. This defect area 16 is located on the location of a part Pz to be cut out.

Before cutting out parts that would become unusable (including the part Pz), the cutting method according to the invention will directly prepare a new placement by specifying that no part should be placed on this defect area 16. For that, the defect area 16 is described to the automatic placement module in order to be excluded from the new placement.

FIG. 5B represents one possible result of a new placement prepared in this situation.

Prior to the preparation of the new placement, a list of parts to be maintained is established (i.e. the parts for which the new placement will not modify the position). In the example of FIG. 5B, these are in particular the parts Pc located at the level of the cutting module 10.

The new placement is prepared by taking into account the position of the parts to be maintained Pc and calculates new positions for all or part of the other parts (parts to be repositioned). The part Pz which was previously located on the defect area 16 forms in particular part of these parts to be repositioned.

The new placement is also prepared to optimize the use of the material while avoiding producing parts on the defect area.

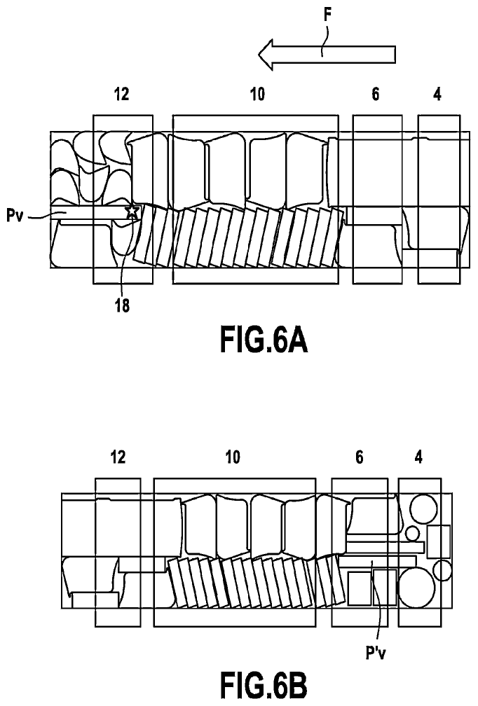

In relation to FIGS. 6A and 6B, one exemplary implementation of the preparation of a new placement will now be described in the case of a triggering event consisting of the detection of a defect on a cut out part that needs to be recut.

In this example, the defect is not detected during the cutting of the parts but when they are unloaded by the operator at the level of the unloading module 12 of the cutting system. In FIG. 6A, the part Pv having a defect 18 has thus been identified by the operator during its unloading.

In such a situation, the known solution consisted in recutting this defect part by preparing an additional placement containing only this part, this additional placement being cut at the end of the current placement (with as a consequence significant material losses).

On the contrary, as represented in FIG. 6B, the method according to the invention provides for establishing a list of parts to be maintained, then establishing a new placement including in particular the part P′v to be recut.

The new placement is prepared in order to optimize the use of the material by taking into account the position of the parts to be maintained and calculates new positions for all or part of the other parts (parts to be repositioned). The defect part P′v which must be recut forms in particular part of one of these parts to be repositioned.

Since the defect part is detected as being defective during the unloading of the parts, it is possible that the initial placement Qi was completely cut out upon detection of this defect part.

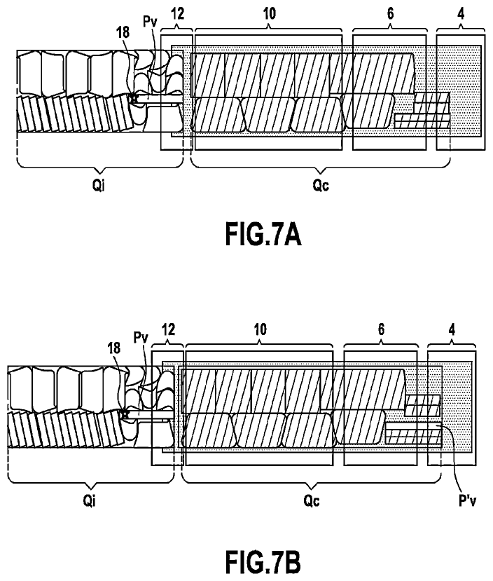

In this particular case illustrated by FIGS. 7A and 7B, if the current placement Qc (which follows the initial placement Qi) is made on the same material, the defect part P′v can then be integrated into the current placement Qc.

In other words, the new placement prepared according to the invention comprises not only the defect part P′v, but also all the parts belonging to the current placement Qc.

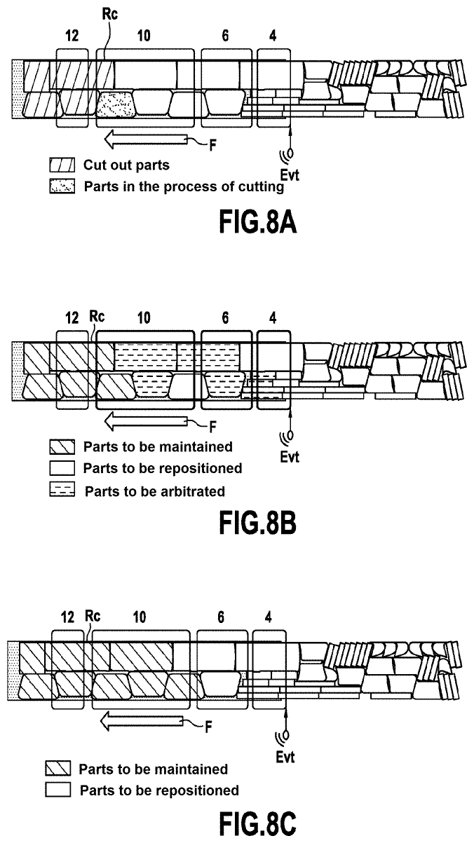

In relation to FIGS. 8A to 8C, the way in which the lists of parts to be maintained (corresponding to step S6 of the method according to the invention) and of parts to be repositioned during the preparation of the new placement are established will now be described (step S7 of the method according to the invention).

The parts to be maintained are the parts for which the position in the new placement will not be modified. The parts to be repositioned are the parts whose position will be recalculated automatically for the new placement.

FIG. 8A represents one example of initial placement in the process of cutting with the different modules of the cutting system disposed from upstream to downstream in the advancing direction F of the material: supply module 4, acquisition module 6, cutting module 10 and unloading module 12.

Among all the parts of the initial placement, there is a distinction between the parts with hatches that have already been cut out and the part with points which is a part in the process of cutting.

In this example, the triggering event Evt consists of the detection of the end of the current roll Rc on which the material spread on the cutting table is packaged.

FIG. 8B illustrates the different categories to which the parts of the initial placement are assigned as soon as the triggering event Evt (end of the roll) is detected, namely:
1/Parts to be maintained (parts with hatches): these are parts that are already cut out or in the process of being cut. These parts are therefore necessary to be maintained at their initial position and therefore placed in the group of the “parts to be maintained”.
2/Parts to be repositioned (empty parts): these are parts that cannot maintain their initial positioning, because they cannot be correctly cut (in the example, these are all the parts that are not on the current roll Rc on the cutting table or those astride the end of the current roll Rc). These parts are therefore necessary to be repositioned and therefore placed in the group of the “parts to be repositioned”.
3/Parts to be arbitrated (parts with dotted lines): the other parts of the placement.

It is then necessary to categorize each of the parts to be arbitrated in one of the two groups (parts to be maintained or parts to be repositioned).

The choice of categorization of these parts to be arbitrated must take into account the fact that in order to promote the efficiency, all these parts should be considered as “to be repositioned” (the greater the number of parts to be repositioned, the greater the placement algorithm will have possible combinations, which will allow it to achieve greater efficiency).

But it is also necessary to take into account that in order to continue the production, therefore, to continue the cutting, all the parts should be considered “to be maintained” (the greater the number of parts to be maintained, the stronger the probability of receiving the placement result before the machine stops cutting).

To this end, advantageously, the invention provides for determining the number of parts belonging to the group “parts to be maintained” according to an evaluation of their cutting time and the time allocated to the calculation of the new placement.

Indeed, having an evaluation of the cutting time of each part, it is possible to estimate the remaining cutting time, that is to say the sum of the cutting times of all the maintained parts. If no part is present in the group “to be maintained” or if they are all already cut out, the remaining cutting time is zero. In this case, the cutting will stop the time to receive the new placement.

The time of preparation of the new placement can be limited to a time given by the software. Thus, it is possible to impose on the automatic placement module a maximum calculation time and to maintain a number of parts whose cutting time corresponds to this maximum calculation time (as well as a possible fixed additional cost serving as a margin).

This search for parts is advantageously carried out by favoring the parts closest to the unloading module 12. This arbitrary choice allows maintaining a fluidity of the process by proposing the operator parts to be unloaded.

The result obtained is illustrated in FIG. 8C in which the parts to be arbitrated in FIG. 8B have been categorized into one of two groups (parts to be maintained: parts with hatches; and parts to be repositioned: empty parts).

It should be noted that the choice of categorization of these parts to be arbitrated (in one of the two groups: parts to be maintained or parts to be repositioned) can also depend on the fact that some parts to be arbitrated have a placement constraint (case of a material to be cut out consisting of a patterned fabric) or a proximity constraint.

Particularly, when it comes to a placement on a patterned material, the constraints of connections between the parts intervene, and the categorization of the parts to be arbitrated must take this into account.

Indeed, when there is a constraint of connection between two parts, the notion of master part and daughter part appears. The master part gives the indications of its positioning to the daughter part such that it is positioned correctly. A daughter part therefore cannot be positioned if its master part has not been positioned. This explains why a daughter part cannot be assigned to the group “to be maintained” if, on the other hand, its master part has been placed in the group “to be repositioned”.

It is also necessary to take into account the possibility that a daughter part can itself be the master part of another part, just as a master part can itself be the daughter part of another part.

In this context, as soon as a master part is assigned to the group “to be repositioned”, all its daughter parts are also assigned.

In the case where the master part is assigned to the group “to be maintained”, all of its daughter parts can be placed in the group “to be repositioned”, taking into account their constraint imposed by the master part.

As for the parts with a proximity constraint, there is a distinction between:
1/Proximity/alignment constraint (quality constraint) which forces two parts to maintain their relative placement relative to each other, in order to ensure, for example, the perfect continuity of the yarn.

These parts form a fixed and indivisible block of parts. This means that these parts will be either all assigned to the group “to be maintained” on the current roll, or all assigned to the group “to be repositioned” and placed on the next roll, while maintaining their relative positioning.
2/Proximity constraint limiting the distance between the linked parts and their master:
either to guarantee the cutting of the parts (proximity −X): this “proximity −X” is the distance limiting the remoteness of the master part from its “daughter”, when the latter is placed before its master, so that they are both in the same cutting window;
or to guarantee the quality of the product (stability of the color on the roll, whose bath deteriorates over the length), the distance between the master part and the linked parts can be limited on all the other axes: proximity +X to limit the distance between master part and linked part when the latter is placed after the master part, proximity +Y/−Y to limit the distance between linked part and master part when the first one is placed above—respectively below—the master part).

In this case, these parts also form a fixed and indivisible block of parts, so that these parts will be either all assigned to the group “to be maintained” on the current roll, or all assigned to the group “to be repositioned” and placed on the next roll, while maintaining their relative positioning. However, this constraint is not always met. This is particularly the case when a part of the group is already cut out and must be maintained while another part must be necessarily repositioned.

Once the assignment to one of the two groups of the parts to be arbitrated has been made, the production can resume (if it has been interrupted) or continue (if it has not been interrupted) in parallel with the preparation of the new automatic placement (step S7 of the method).

In addition to the placement or proximity constraints associated with each part or imposed by the material, it is necessary to specify new information in order to establish the new placement.

As seen previously, the time of preparation of the new placement is limited by the remaining cutting time. In addition, the processing can be interrupted if a certain efficiency value is reached.

The system can therefore parameterize the preparation of the new automatic placement by giving a maximum calculation time and a target efficiency.

Furthermore, the dimensions of the area for the new placement will depend on the material on which the new placement will be made. These dimensions depend on the context of the new placement, namely:
1/The width which can be given by the strip width measured on the machine, or taken from the material characteristics, a limitation can be given by the strip width measured on machine, or taken from the material characteristics.
2/A limitation of placement Xmax can be imposed. In the case where the end of roll is known, it is defined by the detection of the end of roll. In the case where the end of roll is not known, then this limitation is infinite.
3/A placement limitation Xmin can be specified to avoid positioning parts on an area that would become inaccessible by the cutting module with the continuation of the cutting. Indeed, as the cutting continues, the cutting module and the automatic placement module share the limit position that can be discharged from the cutting area. This position will be the value usable by the placement module. This Xmin must take into account the space left accessible by the parts to be repositioned and the areas inaccessible by the cutting module or by the maintained parts.

For each part to be maintained Pc(i), the maximum Max(i) is calculated, and for each part to be repositioned Pr(j), the minimum Min(j) is calculated. The limitation Xmin will be equal to the largest of the Max(i) less than the set of the Min(j). The cutting module must guarantee that this placement position will not be discharged from the cutting area.

During the automatic preparation of the new placement, the production can resume, which allows the cutting of the retained parts to continue, as well as their unloading. However, to avoid bringing usable material for the placement of the parts into an area inaccessible to the cutting module, the advances of the conveyor must be limited to the same value as the position Xmin of the placement of the authorized parts.

Thus limited, the production can resume its course: the repositioning of the parts will always be limited to an area accessible by the cutting module regardless of the advances of the conveyor.

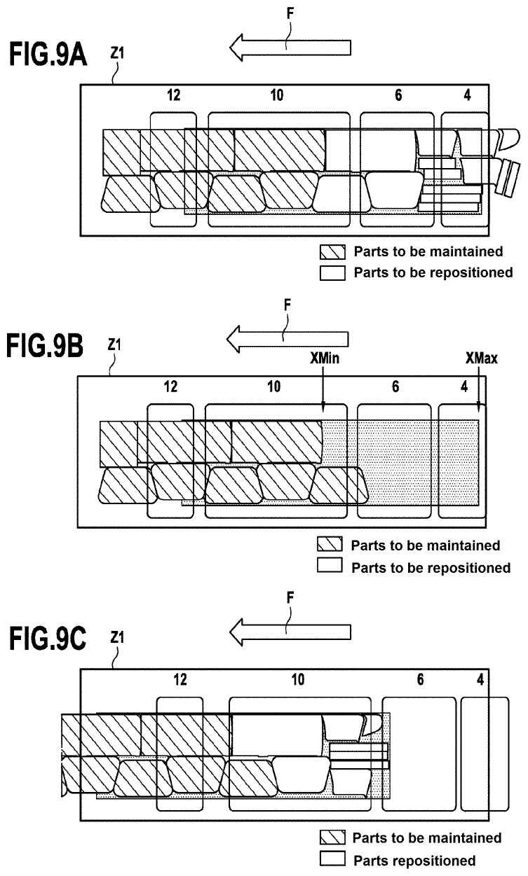

FIGS. 9A to 9C represent the different steps of one exemplary implementation of the characteristics of the new placement according to the method of the invention.

FIG. 9A thus represents the possible area Z1 on the surface of the cutting table for the new placement, as well as the parts of the initial placement belonging to the group “to be maintained” and those belonging to the group “to be repositioned”.

FIG. 9B represents the information sent to the automatic placement module for the preparation of the new placement, namely: the placement limitations Xmax and Xmin which define the limits for the preparation of the new placement, the parts to be maintained that are placed, and a list of parts to be repositioned that are no longer placed.

Finally, FIG. 9C shows the location of the new prepared placement for the repositioned parts.

Furthermore, as described previously, the case of the placements on patterned material adds the constraints of connections between parts. In addition, when choosing the categorization of the parts “to be maintained” or “to be repositioned”, a daughter part can be separated from its master part. In addition, even if the daughter part and the master part belong to the group “to be repositioned”, there is no guarantee that the two parts can be positioned on the same placement.

In the case where the master part is positioned on the first new placement and the daughter part on the second new placement, a processing quite similar to the one set out in patent application FR 20 02947 filed on Mar. 26, 2020, by the Applicant is set up. It amounts to transforming the point of connection of the daughter part into patterned point in order to guarantee that this part can be processed independently of its master part.

Contrary to the case of patent application FR 20 02947, the final position of the master part may not be known at the time of this transformation. To obtain a result that remains acceptable, an extrapolation of the actual position of the part will be made as a function of the length of the actual pitch. A framework (actual theoretical framework) will be built from the theoretical framework but by taking as a pitch length the pitch actually measured at the time of cutting (the average value of the last two lines).

If a part is linked to two master parts (one along each axis) at two different attachment points, then the pattern point created will be calculated from the intersection (projection on each axis) of the attachment points from the extrapolated position of the master parts.

Otherwise, when a daughter part is placed in the first new placement and the master part in the second new placement, the extrapolated position of the master part cannot be known (in particular because the actual pitch of the new roll is not known). The transformation of the connection point into pattern point cannot be applied. This part cannot therefore be processed. In order not to end up in this scenario, a parameter of the automatic placement module allows guaranteeing that a part will only be positioned in a new placement if all its master parts are already positioned there.

How the productivity can be improved will now be described.

The objective of the new placement is to respond to a problem requiring a modification of the initial placement with the least possible impact on the productivity. For this purpose, the calculation time of the new placement will be masked by the cutout of parts which have been maintained in their initial position. This therefore implies that the time allocated for making the new placement is set.

In some cases, the calculation time will be short because the problem to be solved involves great reactivity. This is the case, for example, of the detection of defects when the material area that cannot be used is known shortly before the parts thereon are cut. Thus, few parts can be assigned to the group “to be maintained”, and therefore the placement time will be short.

In the case where the triggering event occurs far from the end of the initial placement, many parts will have to be replaced. Given the placement time constraint explained above, the result of the placement may not be satisfactory. In this case, a second phase of optimization can be applied. It will work similarly to the first one (maintain parts to be cut to hide the calculation time and replace the others). This time, a larger number of parts will be maintained in order to allow the automatic placement module to prepare a second placement but with a longer calculation time. The parts of this second result (better than the first one) can be integrated into the placement in the process of cutting and without interruption.

1.-16. (canceled)

17. A method for automatically cutting parts in a flexible material packaged in the form of a roll, comprising the successive steps of:
a) preparing an initial placement for a list of parts to be cut out in the flexible material;
b) spreading at least one layer of flexible material on a cutting table;
c) starting the automatic cutting of the parts in the material spread on the cutting table according to the initial placement;
d) during the cutting of the initial placement, upon receipt of a triggering event for which the placement of at least one of the parts is no longer adapted to the cutting environment or for which the list of the parts of the initial placement needs to be modified, preparing a list of parts to be maintained; and
e) automatically preparing a new placement taking into account the position of the parts to be maintained and calculating new positions for all or part of the other parts—called parts to be repositioned—without taking into account their positions in the initial placement.

18. The method according to claim 17, wherein step e) is followed by a step f) of automatically cutting the parts in the material spread on the cutting table according to the new placement.

19. The method according to claim 17, wherein the new placement prepared in step e) comprises all or part of the parts of the initial placement that are still to be cut out.

20. The method according to claim 19, wherein the new placement prepared in step e) further comprises one or several parts for which the placement is no longer adapted to the cutting environment.

21. The method according to claim 19, wherein step d) comprises the determination of the number of the parts to be maintained that are still to be cut out according to an evaluation of their cutting time and to the time allocated to the calculation of the new placement.

22. The method according to claim 21, wherein the time allocated to the calculation of the new placement is less than the evaluation of the cutting time of the parts to be maintained that are still to be cut out.

23. The method according to claim 19, wherein the selection of the parts of the new placement among all the parts of the initial placement that are still to be cut out is made by meeting any constraints of placement of said parts.

24. The method according to claim 17, wherein the triggering event is chosen among: a detection of the end of the roll on which the material spread on the cutting table is packaged, a detection of a defect on the material spread on the cutting table, and a detection of a defect on a cut out part that needs to be recut.

25. The method according to claim 24, wherein, when the triggering event consists of the detection of the end of the roll on which the material spread on the cutting table is packaged, step e) comprises the establishment of a first placement of parts on the end of the roll, and a second placement of the remaining parts on another roll of material.

26. The method according to claim 24, wherein, when the triggering event consists of the detection of a defect on the material spread on the cutting table, the step e) comprises the exclusion of the area of the spread material on which the defect is present in order to establish the new placement.

27. The method according to claim 24, wherein, when the triggering event consists of the detection of a defect on a cut out part that needs to be recut, step e) comprises the addition of the defect part to the new placement.

28. The method according to claim 17, wherein the new placement of step e) is prepared so as to minimize any loss of productivity.

29. The method according to claim 28, wherein step e) is carried out without interrupting the cutting of the parts to be maintained that are still to be cut out according to the initial placement.

30. The method according to claim 17, wherein step e) of preparing the new placement is carried out iteratively in order to obtain the highest possible efficiency rate.

31. The method according to claim 17, wherein step c) comprises a prior step of modifying the initial placement to generate an actual placement of the parts on the spread material which takes into account the actual characteristics of the material.

32. A system for automatically cutting parts in a flexible material packaged in the form of a roll, comprising:
means for preparing an initial placement of a list of parts to be cut out in the flexible material;
a cutting table on which at least one layer of flexible material can be spread;
means for automatically cutting the parts in the material spread on the cutting table according to the initial placement;
means for receiving, during the cutting of the initial placement, a triggering event for which the placement of at least one of the parts is no longer adapted to the cutting environment or for which the list of the parts of the initial placement needs to be modified; and
means for automatically preparing a list of parts to be maintained and a new placement taking into account the position of the parts to be maintained and calculating new positions for all or part of the other parts—called parts to be repositioned—without taking into account their positions in the initial placement.
